(19) United States
(12) Patent Application Publication
(10) Pub. No.: US 2024/0332700 A1
(43) Pub. Date: Oct. 3, 2024

(54) BATTERY MODULE

(71) Applicant: HONDA MOTOR CO., LTD., Tokyo (JP)

(72) Inventors: Takeo FUJII, Saitama (JP); Takuya TANIUCHI, Saitama (JP)

(21) Appl. No.: 18/585,070

(22) Filed: Feb. 23, 2024

(30) Foreign Application Priority Data
Mar. 31, 2023 (JP) 2023-058522

(51) Int. Cl. H01M 50/242; H01M 50/172; H01M 50/204; H01M 50/289; H01M 50/516

(52) U.S. Cl. CPC H01M 50/242; H01M 50/172; H01M 50/204; H01M 50/289; H01M 50/516

(57) ABSTRACT

The battery module includes a plurality of battery cells, each battery cell being provided with an electrode stack accommodated in an exterior body and a tab lead that is connected to the electrode stack and extends from the exterior body, the battery module having a pair of end plates that retain the battery cells, the end plates being disposed at both ends of the electrode stacks in an electrode stacking direction, the tab lead being electrically connected to the tab lead of another of the battery cells that is adjacent, and the tab lead having a first extension that extends in a direction orthogonal to the electrode stacking direction and a second extension that extends in a direction in which the another of the battery cells is adjacent.

This application is based on and claims the benefit of priority from Japanese Patent Application No. 2023-058522, filed on 31 Mar. 2023, the content of which is incorporated herein by reference.

### BACKGROUND OF THE INVENTION

### Field of the Invention

The present invention pertains to a battery module.

### Related Art

In recent years, research and development pertaining to secondary batteries that contribute to improving energy efficiency has been carried out in order to ensure access to sustainable and advanced energy that is affordable and can be trusted by more people.

In a battery module that has a plurality of battery cells, the battery cells expand and contract in conjunction with charging and discharging. Accordingly, in the battery module, for example, the plurality of battery cells are retained by a pair of end plates that are provided at both ends of a battery cell stack in a stacking direction.

FIG. 8 is a top surface view that schematically illustrates a configuration of a conventional battery module 200. As illustrated in FIG. 8, in the battery module 200, each of a plurality of battery cells 10 has an electrode stack 1 and an exterior body 2 that accommodates the electrode stack 1. The plurality of battery cells 10 are retained by a pair of end plates 20 and bind bars 30. A cushioning material 11 is disposed between adjacent battery cells 10. A stacking direction for electrodes in the electrode stack 1 is the same as a stacking direction d2 for the plurality of battery cells 10.

A technique pertaining to a secondary battery module, which has a configuration in which an electrode surface direction for battery cells is orthogonal to the direction in which the battery cells are stacked, has been disclosed (for example, refer to Patent Document 1).
Patent Document 1: Japanese Unexamined Patent Application, Publication No. 2013-222603

### SUMMARY OF THE INVENTION

In FIG. 8, tab leads 50a that electrically connect adjacent battery cells 10 to one another are disposed along a stacking direction d2 for the battery cells 10. Here, there is variation in an amount of expansion by each battery cell 10, and thus stress is applied to each tab lead 50a in the stacking direction, and it is possible for the tab leads 50a to deteriorate or be severed. In addition, in the technique disclosed in Patent Document 1, a liquid-based lithium-ion secondary battery that has a separator is presupposed, and consideration is not given to expansion and contraction by battery cells.

The present invention is made in light of the matter described above, and an object of the present invention is to provide a battery module that is provided with a tab lead that is less likely to be impacted by stress that accompanies expansion and contraction by a battery cell.
(1) The present invention pertains to a battery module that includes a plurality of battery cells, each battery cell being provided with an electrode stack accommodated in an exterior body and a tab lead that is connected to the electrode stack and extends from the exterior body, the battery module having a pair of end plates that retain the battery cells, the end plates being disposed at both ends of the electrode stacks in an electrode stacking direction, the tab lead being electrically connected to the tab lead of another of the battery cells that is adjacent, and the tab lead having a first extension that extends in a direction orthogonal to the electrode stacking direction and a second extension that extends in a direction in which the another of the battery cells is adjacent.

By virtue of the invention according to (1), it is possible to provide a battery module that is provided with a tab lead that is less likely to be impacted by stress that accompanies expansion and contraction by a battery cell.
(2) The battery module according to (1), in which the plurality of battery cells are arranged in a direction that is orthogonal to the electrode stacking direction, and cushioning materials are disposed between the battery cells and the end plates.

By virtue of the invention according to (2), it is possible to provide a battery module that is provided with a tab lead that is less likely to be impacted by stress that accompanies expansion and contraction by a battery cell.
(3) The battery module according to (1) or (2) in which, for a pair of the tab leads that electrically connect a pair of the battery cells that are adjacent to each other, the second extensions are mutually joined to each other, and a pair of the first extensions are respectively joined to different ends of the second extensions in the electrode stacking direction.

By virtue of the invention according to (3), it is possible to reduce stress that accompanies expansion and contraction by a battery cell and is applied to a joint section for tab leads.

### BRIEF DESCRIPTION OF THE DRAWINGS

FIG. 1 is a top surface view that conceptually illustrates a configuration of a battery module according to an embodiment;

FIG. 2 is a cross-sectional view that illustrates a configuration of a lead tab and a battery cell according to the embodiment;

FIG. 3 is a top surface view that illustrates a configuration of the lead tab and the battery cell according to the embodiment;

FIG. 4 is a perspective view that illustrates a configuration of the lead tab according to the embodiment;

FIG. 5 is a top surface view that illustrates a configuration of the lead tab according to the embodiment;

FIG. 6 is a side surface view of the battery module in FIG. 1;

FIG. 7 is a side surface view that illustrates a configuration of a cooling member in the battery module in FIG. 1;

FIG. 8 is a top surface view that conceptually illustrates a configuration of a conventional battery module;

FIG. 9 is a cross-sectional view that illustrates a configuration of a lead tab and a battery cell according to another embodiment; and

FIG. 10 is a cross-sectional view that illustrates a configuration of a lead tab and a battery cell according to another embodiment.

### DETAILED DESCRIPTION OF THE INVENTION

### First Embodiment

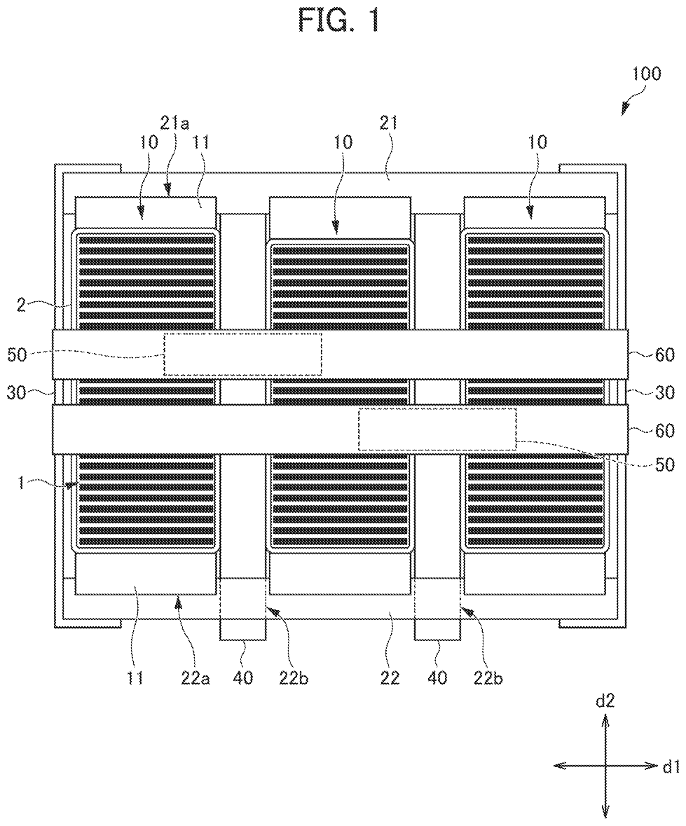

With reference to the drawings, description is given below regarding embodiments of the present invention. As illustrated in FIG. 1, a battery module 100 is provided with a plurality of battery cells 10. The plurality of battery cells 10 are retained by a pair of end plates 21 and 22, and bind bars 30. Cushioning materials 11 are respectively disposed between the plurality of battery cells 10 and the pair of end plates 21 and 22. Cooling members 40 are respectively disposed between adjacent battery cells 10. Adjacent battery cells 10 are electrically connected by tab leads 50. The top surface of each tab lead 50 is covered and insulated by an insulation cover 60.

### (Battery Cell)

Each battery cell 10 is not limited in particular, but may be, inter alia, a non-aqueous electrolytic solution battery cell or a solid-state battery cell, for example. The battery module 100 according to the present embodiment has a structure that enables the plurality of battery cells 10 to be retained at a relatively uniform surface stress. Accordingly, the configuration of the battery module 100 according to the present embodiment is particularly effective in a case of using, as the battery cells 10, solid-state battery cells that have high expansion and contraction due to charging and discharging.

The abovementioned solid-state battery may be, inter alia, a semi-solid-state lithium-ion battery that has a gelatinous electrolyte or an all-solid-state lithium-ion battery that has a solid electrolyte, for example. In particular, it is desirable for a solid-state battery to be an all-solid-state lithium metal battery or a semi-solid-state lithium metal battery that uses lithium metal for a negative electrode, or an all-solid-state lithium-ion battery or a semi-solid-state lithium-ion battery that uses a silicon compound for a negative electrode. This is because such solid-state batteries have comparatively high expansion and contraction due to charging and discharging. Description is given below by taking, as an example, a case where each battery cell 10 is an all-solid-state lithium metal battery cell.

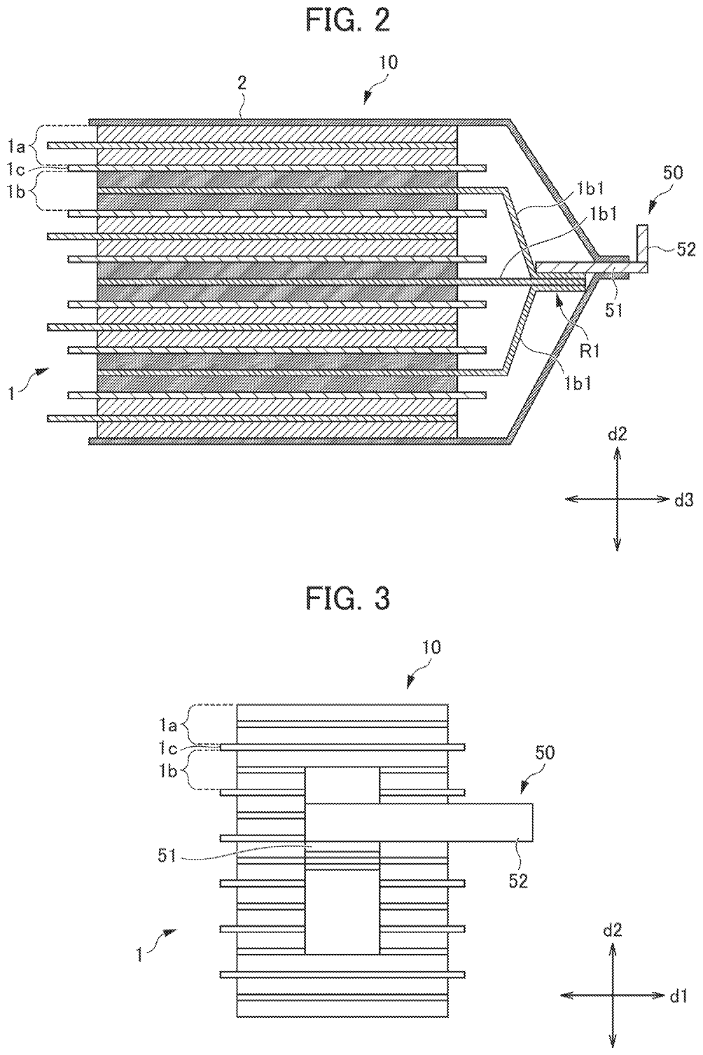

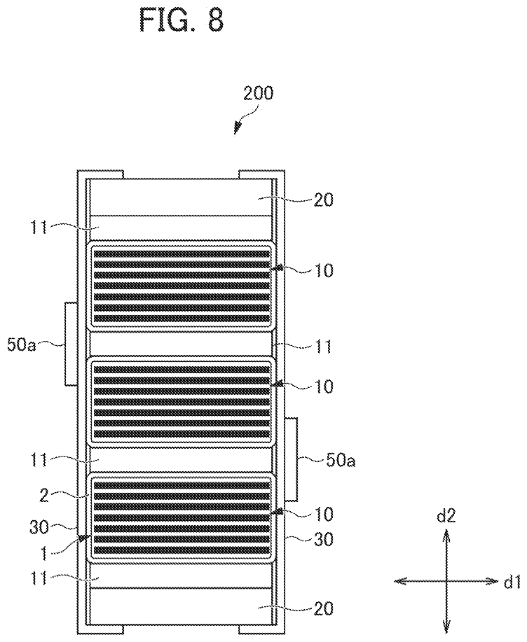

As illustrated in FIG. 2 and FIG. 3, for example, an all-solid-state lithium metal battery cell has an electrode stack 1 in which a positive electrode 1b that includes a positive electrode current collector and a positive electrode mixture layer, a solid electrolyte layer 1c, and a negative electrode 1a that includes a lithium metal layer and a negative electrode current collector are sequentially stacked. Note that, in FIG. 1 and FIG. 8, the arrangement of positive electrodes and negative electrodes, which are electrodes that are accommodated inside an exterior body 2, is schematically illustrated by black lines. In other words, a stacking direction for the electrodes in FIG. 1 is a direction d2.

The positive electrode current collector is not limited in particular, but may be aluminum foil or the like, for example.

The positive electrode mixture layer includes a positive electrode active material, and may also include a solid electrolyte, an electrically conductive aid, a binder, or the like.

The positive electrode active material is not particularly limited if the positive electrode active material can occlude and discharge lithium ions, but may be, inter alia, LiCoO₂, Li (Ni_{5/10}Co_{2/10}Mn_{3/10}) O₂, Li (Ni_{6/10}Co_{2/10}Mn_{2/10}) O₂, Li (Ni_{8/10}Co_{1/10}Mn_{1/10}) O₂, Li (Ni_{0.8}Co_{0.15}Al_{0.05}) O₂, Li (Ni_{1/6}CO_{4/6}Mn_{1/6}) O₂, Li (Ni_{1/3}CO_{1/3}Mn_{1/3}) O₂, LiCoO₄, LiMn₂O₄, LiNiO₂, LiFePO₄, lithium sulfide, or sulfur, for example.

A solid electrolyte for constituting the solid electrolyte layer is not limited in particular if the solid electrolyte is a material that can conduct lithium ions, but may be, inter alia, an oxide-based solid electrolyte or a sulfide-based solid electrolyte, for example.

As the lithium metal layer that includes lithium metal which is a negative electrode active material, it is possible to use matter that uses solely lithium metal or a lithium alloy, or matter resulting from mixing these. The negative electrode current collector is not limited in particular, but may be copper foil or the like, for example.

The electrode stack 1 is accommodated in the exterior body 2. The exterior body 2 is not limited in particular, but may be, inter alia, a laminate film, for example.

An electrode stacking direction of the electrode stack 1 is the direction d2 in FIG. 1. In contrast to this, a cell stacking direction in which the plurality of battery cells 10 are stacked is a direction d1 that is orthogonal to the electrode stacking direction d2. By virtue of the abovementioned configuration, it is possible to respectively dispose the cushioning materials 11 between ends of respective battery cells 10 in the electrode stacking direction, and the pair of end plates 21 and 22. Note that three battery cells 10 are stacked in FIG. 3, but the number of battery cells 10 that are stacked is not limited in particular.

In a conventional battery module 200 in which the cell stacking direction and the electrode stacking direction are the same as in FIG. 8, the stress applied to the plurality of battery cells 10 is the same. However, there is variation in a level of expansion and contraction due to charging and discharging by the plurality of battery cells 10, and thus stress is applied in the stacking direction to the tab leads 50a in the structure of the battery module 200, and there is a risk that the tab leads 50a will deteriorate or break. Consideration can be given to constituting each tab lead 50a by a structure or material that can expand and contract, but the structure or material for a tab lead is limited in the method described above. In addition, the structure of the battery module 200 does not enable an appropriate load, which corresponds to the level of expansion and contraction by each battery cell 10, to be applied. Accordingly, due to a greater-than-envisioned load, it is possible for the durability of the module to decrease or it is possible to a difference in performance for respective battery cells 10 to arise.

In contrast to the battery module 200 described above, the direction d1 which is the cell stacking direction and the direction d2 which is the electrode stacking direction are orthogonal to each other in the battery module 100 described above. As a result, it is less likely that stress accompanying expansion and contraction by each battery cell 10 will be applied to the tab leads 50 that are respectively disposed between adjacent battery cells 10. Accordingly, it is possible to suppress deterioration, breakage, or the like for the tab leads 50. Description is given below regarding details of the tab leads 50.

In addition, in the battery module 100 described above, the cushioning material 11 is disposed for each battery cell 10, and the stress that can be applied to each battery cell 10 differs in accordance with the level of expansion and contraction by the battery cell 10. Accordingly, it is possible to control the stress that can be applied to each battery cell 10 to an appropriate stress that corresponds to the level of expansion and contraction.

### (Cushioning Material)

The cushioning materials 11 are respectively disposed by being in contact between both end surfaces of each battery cell 10 in the electrode stacking direction, and surfaces of the pair of end plates 21 and 22 that face each other. Each cushioning material 11 absorbs surface stress that occurs due to expansion and contraction by a battery cell 10, such that the surface stress becomes more or less constant. Such a cushioning material 11 may be matter that is configured by including a viscoelastic material, for example.

The viscoelastic material is not limited in particular, but may be, inter alia, a rubber such as silicone rubber, ethylene propylene diene rubber (EPDM), styrene butadiene rubber (SBR), or nitrile rubber (NBR); or an elastomer such as a thermoplastic polyurethane elastomer (TPU), a thermoplastic polyamide elastomer (TPA), a thermoplastic polyester elastomer (TPC), a thermoplastic olefin elastomer (TPO), a thermoplastic styrene elastomer (TPS), or a dynamically-crosslinked thermoplastic elastomer (TPV), for example.

### (End Plates)

The pair of end plates 21 and 22 have surfaces that are in contact with both end surfaces of the plurality of battery cells 10 in the electrode stacking direction, with at least cushioning materials 11 interposed therebetween. In other words, the plurality of battery cells 10 and a pair of cushioning materials 11 are sandwiched by the abovementioned surfaces that belong to the pair of end plates 21 and 22 and are in contact therewith. In this state, the pair of end plates 21 and 22 are immobilized by the bind bars 30. As a result, a retaining pressure is applied at a relatively uniform surface stress with respect to the plurality of battery cells 10 in the electrode stacking direction.

It is desirable that recesses 21a and 22a are respective formed in surfaces that belong to the pair of end plates 21 and 22 and face each other. It is desirable for the recesses 21a and 22a to each be able to accommodate at least a portion of a cushioning material 11, and be formed in alignment with the size of the cushioning material 11. The recesses 21a and 22a are formed in accordance with the number of cushioning materials 11. It is possible to use the recesses 21a and 22a to position the cushioning materials 11. Accordingly, it is possible to facilitate assembly of the battery module 100. In addition, because each battery cell 10 is disposed in alignment with a positioned cushioning material 11, it is guaranteed that the angle between the electrode stacking direction of each battery cell 10 and the cell stacking direction is a right angle.

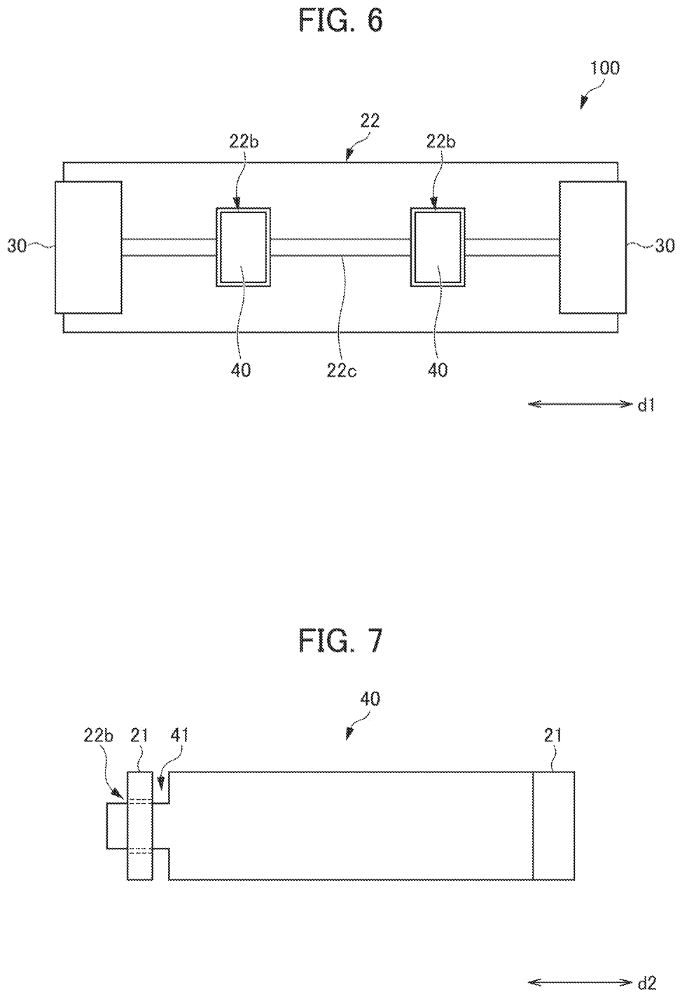

As indicated in FIG. 6 and FIG. 7, it is desirable for each through hole 22b, into which a later-described insertion section 41b that is at least a portion of a cooling member 40 can be inserted, to be formed in the end plate 22 from among the pair of end plates 21 and 22. The through holes 22b are structured in order to position the cooling members 40 and in order to prevent stress due to change of the interval between the pair of end plates 21 and 22 being transmitted to the cooling members 40. As a result, it is possible to facilitate assembly of the battery module 100. In addition, as a material constituting the cooling members 40, it is possible to use, for example, a metal, a ceramic, or the like that has low elasticity or flexibility. The through holes 22b are formed in accordance with the number of cooling members 40.

The cross-sectional shape of each through hole 22b is a quadrilateral in FIG. 6 and FIG. 7, but there is no limitation to this and may be a polygon or a circle. However, it is desirable for the cross-sectional shape to be in accordance with the shape of the insertion section 41. Furthermore, in a state where the insertion section 41 is inserted into the through hole 22b, it is desirable for the gap between the through hole 22b and the insertion section 41 to be as small as possible—to a level that does not obstruct movement of the end plate 22 that accompanies expansion and contraction by a battery cell 10. As a result, it is possible to make the retaining pressure applied to the plurality of battery cells 10 be uniform.

It is desirable for the end plate 22 to be provided with a rib 22c as illustrated in FIG. 6. The rib 22c is formed so as to protrude on the surface of the end plate 22 that is opposite to the end plate 21. It is desirable for the rib 22c to be provided along the direction d1 at a position that spans a plurality of through holes 22b. As a result, it is possible to suppress deflection by the end plate 22 in which the through holes 22b are formed.

FIG. 1 and FIG. 6 illustrate a configuration in which the through holes 22b and the rib 22c is formed on only the end plate 22 from among the pair of end plates 21 and 22, but there is no limitation to this. Holes similar to the through holes 22b and a rib similar to the rib 22c may also be formed in the end plate 21 which is the other one from among the pair of end plates 21 and 22.

### (Cooling Members)

As illustrated in FIG. 1, the cooling members 40 are arranged along the electrode stacking direction d2 between adjacent battery cells 10. By virtue of this arrangement, it is possible to improve the efficiency of cooling the battery cells 10.

In a conventional battery module 200 as in FIG. 8, cushioning materials 11 are arranged between adjacent battery cells 10, and thus it is difficult to also dispose cooling members between battery cells 10. Accordingly, it has been normal practice to arrange cooling members 40a on the top surface or the bottom surface of a plurality of battery cells 10, along the cell stacking direction for the plurality of battery cells 10. However, with such an arrangement, for a battery cell 10 for which the height thereof is greater than the length of the bottom surface thereof, the heat transfer distance from within the battery cell 10 to a cooling member 40a is relatively long, and thus a desirable cooling efficiency cannot be achieved. In contrast to this, in the battery module 100 according to the present embodiment, the cooling members 40 are arranged at the side surfaces of adjacent battery cells 10, and thus it is possible to have a relatively short heat transfer distance from within a battery cell 10 to a cooling member 40. Furthermore, the cooling members 40 can be arranged between battery cells 10, and thus it is possible to efficiently cool the battery cells 10 from both ends of each battery cell 10 around the center thereof at which heat is likely to remain. Accordingly, the battery module 100 enables cooling efficiency to be improved and, as a result, enables a C rate or fast charging to be improved.

An example of a cooling member 40 is not limited in particular, but may be a metallic cooling plate, for example.

Viewed from the direction d1 and as illustrated in FIG. 7, the insertion section 41 that can be inserted into a through hole 22b is formed in the cooling member 40. In the present embodiment, the insertion section 41 is prismatic and is formed by cutting out each of the top and bottom of one end of the cooling member 40 in the direction d2. The shape of the insertion section 41 is not limited to the above, and it is sufficient if the shape of the insertion section 41 is smaller than a section of the cooling member 40 other than the insertion section 41 and corresponds to the shape of the through hole 22b. The insertion section 41 may be a cylinder or a polygonal column shape, for example. In a state where the insertion section 41 is inserted into the through hole 22b, the end plate 22 can move in the direction d2. As a result, even in a case where a battery cell 10 has expanded due to charging or discharging, it is possible to prevent stress from being applied to a cooling plate. In a case where holes that are similar to the through holes 22b are formed in the end plate 21, insertion sections that are similar to the insertion sections 41 may also be formed in a cooling member 40 on the end plate 21 side.

### (Tab Leads)

As illustrated in FIG. 2, each tab lead 50 is joined to a plurality of current collector tabs 1b1 (positive electrode current collector tabs in the present embodiment) that are for positive electrodes or negative electrodes in the electrode stack 1. In detail, in a joining region R1 inside the exterior body 2, a plurality of current collector tabs 1b1 are bundled, and joined to the tab lead 50 by a method such as ultrasonic welding. Note that, although the current collector tabs that are joined to the tab lead 50 are described as positive electrode current collector tabs above, a configuration that is similar to the tab lead 50 and the current collector tabs 1b1 in the present specification can also be applied to negative electrode current collector tabs and a tab lead that is joined thereto.

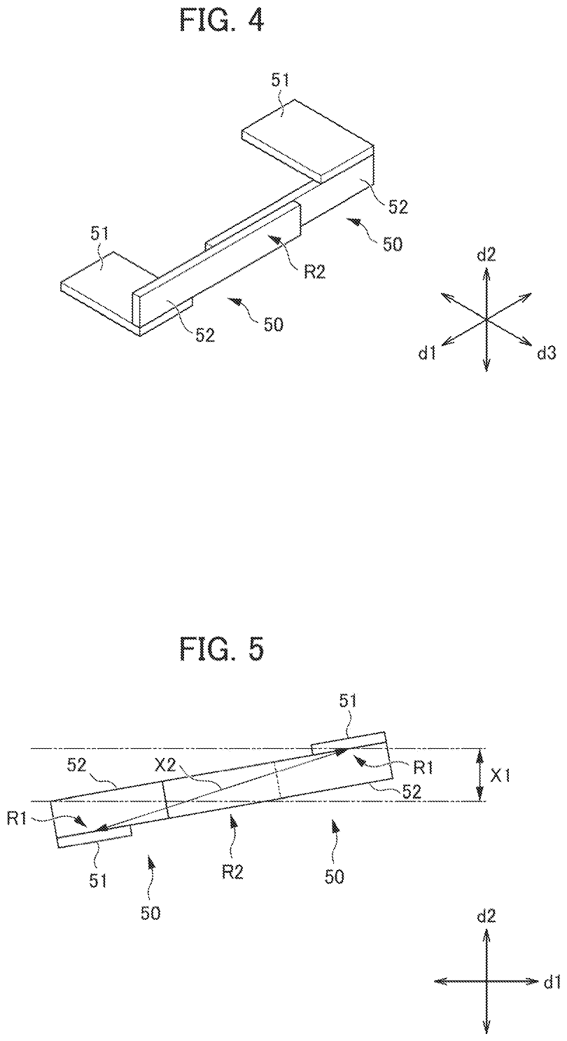

Each tab lead 50 is provided for each of a plurality of battery cells 10 and, as illustrated in FIG. 1 and FIG. 4, is electrically connected to the tab lead 50 of another adjacent battery cell 10 using a method such as welding. FIG. 1 schematically illustrates a region in which a pair of tab leads 50 are arranged. It is desirable for each tab lead 50 to be provided at a central section in the electrode stacking direction d2 for the battery cells 10. As a result, the position of each tab lead 50 is maintained to a certain extent even if the battery cells 10 expand or contract, and thus it is less likely for stress that accompanies expansion and contraction by each battery cell 10 to be applied to the tab lead 50. Note that, for example, the abovementioned central section may mean a region at the center in a case where the length of a battery cell 10 in the electrode stacking direction d2 is equally divided into three.

As illustrated in FIGS. 2-4, each tab lead 50 has a first extension 51 that extends in a direction (a direction d3 in each drawing) that is orthogonal to the electrode stacking direction d2 and the stacking direction d1 for the battery cells 10, and a second extension 52 that extends in the direction (the cell stacking direction d1 for battery cells 10) of another battery cell 10 that is adjacent. The first extension 51 and the second extension 52 are plate-shaped members that are configured by, inter alia, a metal, and may be configured and joined by a separate member. Alternatively, the first extension 51 and the second extension 52 may be integrally formed by bending a plate-shaped member having a substantially L-shape when viewed from above.

As illustrated in FIG. 4, for example, a pair of adjacent tab leads 50 are arranged in contact with each other such that tip ends of second extensions 52 overlap in a top surface view in a joining region R2 and are electrically connected using a method such as welding. By virtue of the above configuration, the direction in which each battery cell 10 expands and contracts is the electrode stacking direction d2, whereas the second extensions 52 belonging to the pair of adjacent tab leads 50 are arranged along the direction d1 that is orthogonal to the electrode stacking direction d2. Accordingly, stress that accompanies expansion and contraction by each battery cell 10 is substantially not applied to the pair of tab leads 50 in the direction d1. Accordingly, it is possible to suppress deterioration or severing that accompanies expansion and contraction by each battery cell 10 and originates at a joining region R2 for tab leads 50.

A method of electrically connecting the above-described second extensions 52 to each other is not limited to FIG. 4 and the description given above. It may be that a connection is made by tip ends of the second extensions 52 abutting each other, or it may be that a connection is made via a separate member.

As illustrated in FIG. 4 and FIG. 5, for a pair of adjacent tab leads 50, it is desirable for a pair of first extensions 51 to be respectively joined to different ends (for example, an upper end and a lower end in FIG. 1) in the electrode stacking direction d2 for the second extensions 52. As a result, it is possible to lengthen a distance X2 between joining regions R1. Accordingly, it is possible to reduce a stress that is applied to the joining region R2 and the joining regions R1 even in a case where, hypothetically, a positional deviation X1 that accompanies expansion and contraction by adjacent battery cells 10 arises, and stress in a rotation direction centered on the joining region R2 is applied to the pair of tab leads 50.

### (Insulation Covers)

Each insulation cover 60 is a member that covers and insulates the top surface of a tab lead 50. In addition to as described above, it may be that the insulation cover 60 restricts movement by the tab lead 50 completely or to a certain extent. As a result, it is possible to reduce stress that is applied to the joining region R2.

A material for constituting the insulation cover 60 is not limited in particular if the material has insulation properties, and may be, inter alia, an insulating resin, for example.

### Second Embodiment

Next, description is given regarding a battery module according to another embodiment of the present invention. Regarding configurations similar to those of the first embodiment, there may be cases below where the same reference symbols are added to drawings and description is omitted.

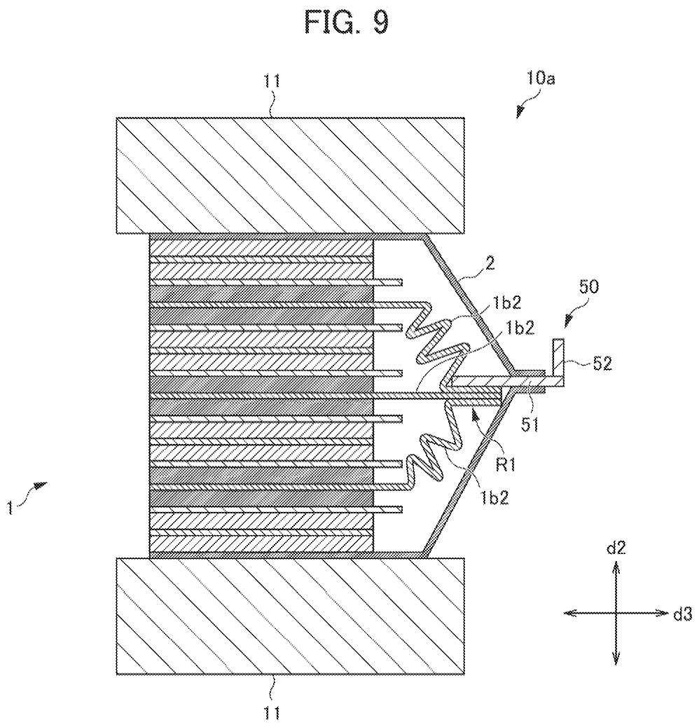

As illustrated in FIG. 9, positive electrode or negative electrode current collector tabs 1b2 (positive electrode current collector tabs in the present embodiment) are joined in a battery cell 10a according to the present embodiment. The battery cell 10a separately has cushioning materials 11. Accordingly, the battery cell 10a expands and contracts substantially uniformly in the electrode stacking direction d2, and the position of the tab lead 50 more or less does not change even if the battery cell 10a expands and contracts. The current collector tabs 1b2 have excess length in accordance with the position of each current collector at a time of maximum expansion (time of SOC 100%) by the battery cell 10a. Accordingly, when the battery cell 10a expands and contracts, it is possible to suppress the current collector tabs 1b2 being pulled and the occurrence of position deviation for the tab lead 50. In addition, it is possible to suppress breakage of the current collector tabs 1b2.

### Third Embodiment

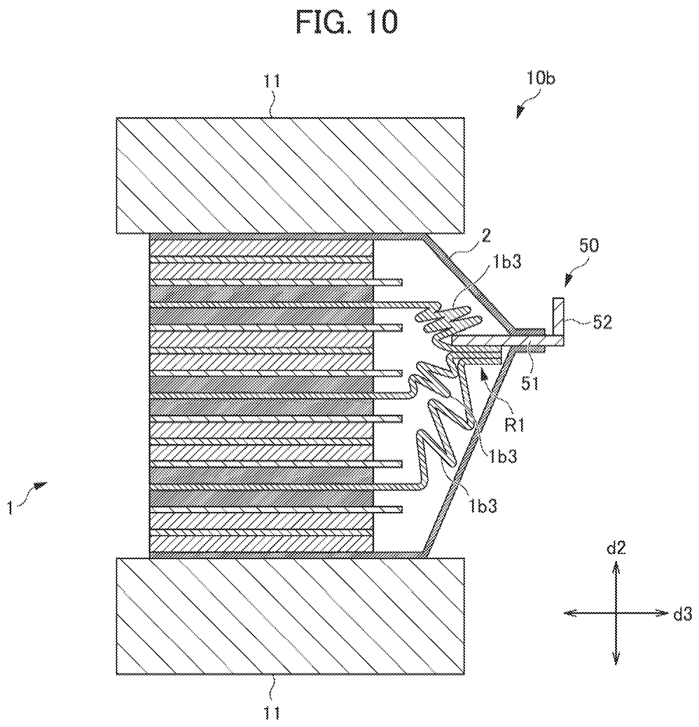

As illustrated in FIG. 10, positive electrode or negative electrode current collector tabs 1b3 (positive electrode current collector tabs in the present embodiment) are joined in a battery cell 10b according to the present embodiment. In the battery cell 10b, the tab lead 50 is disposed somewhat toward an end of the battery cell 10b in the electrode stacking direction d2. Even in a case where the tab lead 50 is disposed in this manner, similarly to in the second embodiment, the battery cell 10b expands and contracts substantially uniformly in the electrode stacking direction d2 by virtue of the cushioning materials 11 that are separately provided, and thus the position of the tab lead 50 more or less does not change even if the battery cell 10b expands and contracts. The current collector tabs 1b3 have excess length in accordance with the position of each current collector at a time of maximum expansion (time of SOC 100%) by the battery cell 10b. Accordingly, an effect that is similar to that of the battery cell 10a according to the second embodiment described above can be achieved.

Description is given above regarding desirable embodiments of the present invention, but the present invention is not limited to the embodiment described above, and the present invention includes modifications and improvements within a range that enables the objective of the present invention to be achieved.

### EXPLANATION OF REFERENCE NUMERALS

100 Battery module
10 Battery cell
1 Electrode stack
11 Cushioning material
2 Exterior body
21, 22 End plate
50 Tab lead
51 First extension
52 Second extension

What is claimed is:

1. A battery module comprising a plurality of battery cells, each battery cell being provided with an electrode stack accommodated in an exterior body, and a tab lead that is connected to the electrode stack and extends from the exterior body,
wherein the battery module has a pair of end plates that retain the battery cells,
the end plates are disposed at both ends of the electrode stacks in an electrode stacking direction,
the tab lead is electrically connected to the tab lead of another of the battery cells that is adjacent, and
the tab lead has a first extension that extends in a direction orthogonal to the electrode stacking direction, and a second extension that extends in a direction in which the another of the battery cells is adjacent.

2. The battery module according to claim 1, wherein
the plurality of battery cells are arranged in a direction that is orthogonal to the electrode stacking direction, and
cushioning materials are disposed between the battery cells and the end plates.

3. The battery module according to claim 1, wherein, for a pair of the tab leads that electrically connect a pair of the battery cells that are adjacent to each other, the second extensions are mutually joined to each other, and a pair of the first extensions are respectively joined to different ends of the second extensions in the electrode stacking direction.
